(19) United States
(12) Patent Application Publication
(10) Pub. No.: US 2008/0058081 A1
(43) Pub. Date: Mar. 6, 2008

(54) Gaming machine which determines award based on combination of symbols with character erased and playing method for gaming machine

(75) Inventor: Katsuhiro Kido, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: ARUZE CORP., Tokyo (JP)

(21) Appl. No.: 11/889,216

(22) Filed: Aug. 9, 2007

(30) Foreign Application Priority Data
Aug. 10, 2006 (JP) 2006-218854

(51) Int. Cl. A63F 13/00

(52) U.S. Cl. 463/20

(57) ABSTRACT

A gaming machine includes a display and a game controller. The display displays thereon a symbol display area in which one of symbols is arranged, and a symbol display frame made up of symbol display areas. When rearranging symbols in the symbol display frame, the game controller performs: displaying, on the symbol display areas, characters for concealing symbols arranged in the symbol display areas; sequentially erasing a part of the characters displayed on the symbol display areas, on a symbol display area basis; and determining an award given to a player, based on a combination of symbols that become visible as a result of erasure of the characters.

### CROSS REFERENCE TO RELATED APPLICATION

This application is based upon and claims the benefit of priority from the prior Japanese Patent Applications No. 2006-218854, filed on Aug. 10, 2006, the entire contents of which are incorporated herein by reference.

### BACKGROUND OF THE INVENTION

1. Field of the Invention

The present invention relates to a gaming machine that gives an award based on a combination of arranged symbols and also relates to a playing method for the gaming machine. More particularly, the present invention relates to a gaming machine that displays a character for concealing an arranged symbol and determines an award based on a combination of symbols resulting from erasure of the character, and also relates to a playing method for the gaming machine.

2. Description of Related Art

Conventionally, in a general gaming machine, symbol display areas, in each of which a column of several symbols is placed, are arranged in a matrix. In such a gaming machine, an award given to a player is determined based on a combination of symbols placed in, among the symbol display areas arranged in the matrix, symbol display areas located on a certain activated pay line of linear shape. However, determining an award based on a combination of symbols placed on a linear activated pay line is too common a manner to be effective in improving pleasure of a player.

Accordingly, a gaming machine that adds variation to the activated pay line and a gaming machine that does not adopt an idea of the activated pay line have now been developed. For example, gaming machines disclosed in U.S. Pat. No. 6,093,102 and in U.S. Pat. No. 6,960,133 are known as a gaming machine that determines an award not only by a combination of symbols placed on a linear activated pay line. In the gaming machines disclosed in the above-mentioned documents, when determining an award, variation is added to the activated pay line or no idea of the activated pay line is adopted. However, presenting a game result to a player by means of symbol display areas arranged in a matrix is eventually equal to determining an award based on a combination of symbols placed on a linear activated pay line. Accordingly, there is no effectiveness in terms of improving pleasure of a player.

### SUMMARY OF THE INVENTION

An object of the present invention is to provide a gaming machine that notifies a game result in a manner different from conventional manners and visually improves pleasure of a player, and also to provide a playing method for the gaming machine.

According to a first aspect of the present invention, there is provided a gaming machine comprising a display and a game controller. The display displays thereon a symbol display area in which one of a plurality of symbols is arranged, and a symbol display frame made up of a plurality of symbol display areas. When rearranging symbols in the symbol display frame, the game controller performs: displaying, on the symbol display areas, characters for concealing symbols arranged in the symbol display areas; sequentially erasing a part of the characters displayed on the symbol display areas, on a symbol display area basis; and determining an award given to a player, based on a combination of symbols that become visible as a result of erasure of the characters.

According to a second aspect of the present invention, there is provided a playing method for a gaming machine. In the playing method, when a game controller rearranges symbols in a symbol display frame that is displayed on a display and made up of a plurality of symbol display areas in each of which one of a plurality of symbols is arranged, the game controller performs: displaying, on the symbol display areas, characters for concealing symbols arranged in the symbol display areas; sequentially erasing a part of the characters displayed on the symbol display areas, on a symbol display area basis; and determining an award given to a player, based on a combination of symbols that become visible as a result of erasure of the characters.

In the first and second aspects, the symbol display frame made up of the plurality of symbol display areas is displayed on the display. When symbols are arranged in the respective symbol display areas, characters that conceal the arranged symbols are displayed on the symbol display areas. A part of the characters displayed on the symbol display areas is sequentially erased on a symbol display area basis. An award given to a player is determined based on a combination of symbols that have become visible as a result of erasure of the characters. Therefore, in the gaming machine and playing method for the gaming machine according to the present invention, an award is determined regardless of a linear activated pay line. This provides a wider variety of display modes on the display. That is, variation is added to a game result presented in the symbol display frame, due to presence and absence of characters in the symbol display areas included in the symbol display frame. Thus, new pleasure can be provided to the gaming machine and the playing method for the gaming machine.

### BRIEF DESCRIPTION OF THE DRAWINGS

Other and further objects, features and advantages of the invention will appear more fully from the following description taken in connection with the accompanying drawings in which:

FIG. 1 is an explanatory view showing a display mode of a lower display while firecracker characters are being erased;

FIG. 2 is an explanatory view showing a display mode of the lower display while firecracker characters are displayed;

FIG. 3 is an explanatory view showing a display mode of the lower display when erasure of firecracker characters is completed;

FIG. 4 is a front view showing a symbol display section according to an embodiment of the present invention;

FIG. 5 is an explanatory view showing columns of symbols in respective reel display areas;

FIG. 6 is a payout table showing awards that are paid out to a player based on combinations of symbols;

FIG. 7 is a perspective view showing an appearance of a gaming machine according to a first embodiment;

FIG. 8 is a block diagram showing a control system of the gaming machine according to the first embodiment;

FIG. 9 is a flowchart showing a main control processing program;

FIG. 10 is a flowchart showing a main game processing program;

FIG. 11 is a flowchart showing a character display processing program;

FIG. 12 is an explanatory view concerning an erasing pattern determination table;

FIG. 13 is an explanatory view showing specific examples of the erasing pattern;

FIG. 14 is a perspective view showing an appearance of a gaming machine according to a second embodiment; and

FIG. 15 is a block diagram showing a control system of the gaming machine according to the second embodiment.

### DESCRIPTION OF THE PREFERRED EMBODIMENTS

In the following, some preferred embodiments of the present invention will be described with reference to the accompanying drawings.

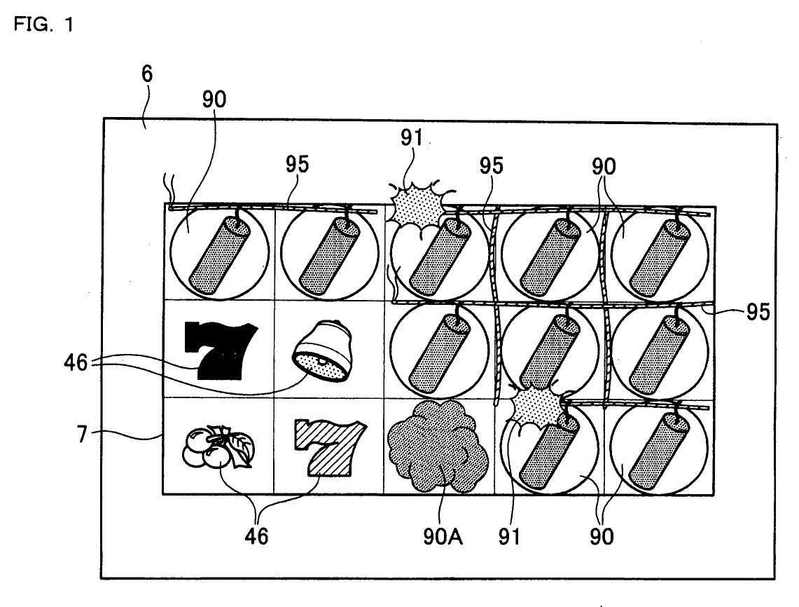

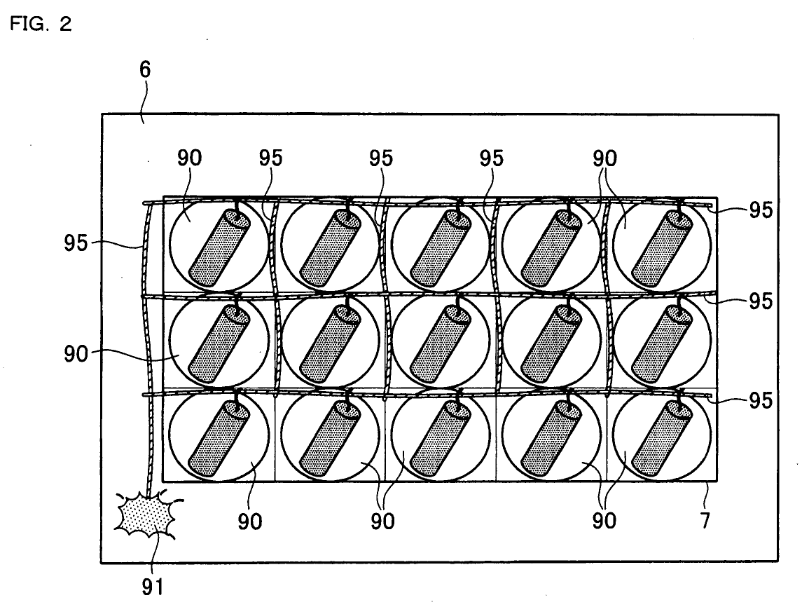

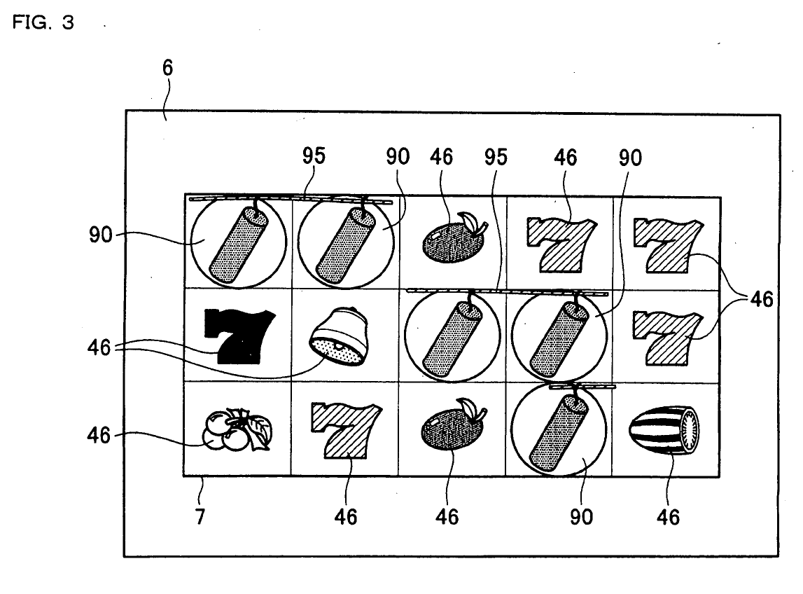

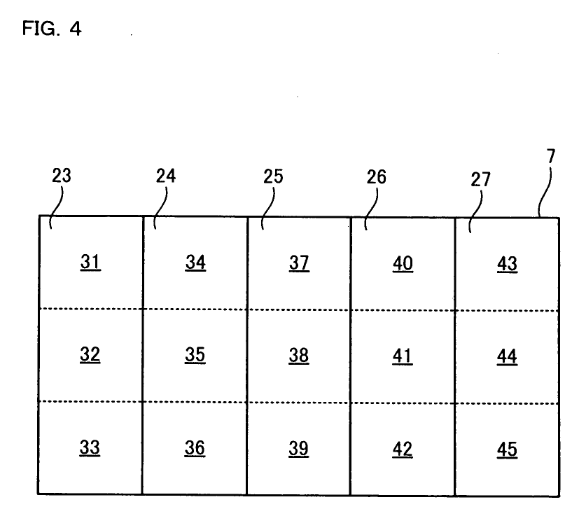

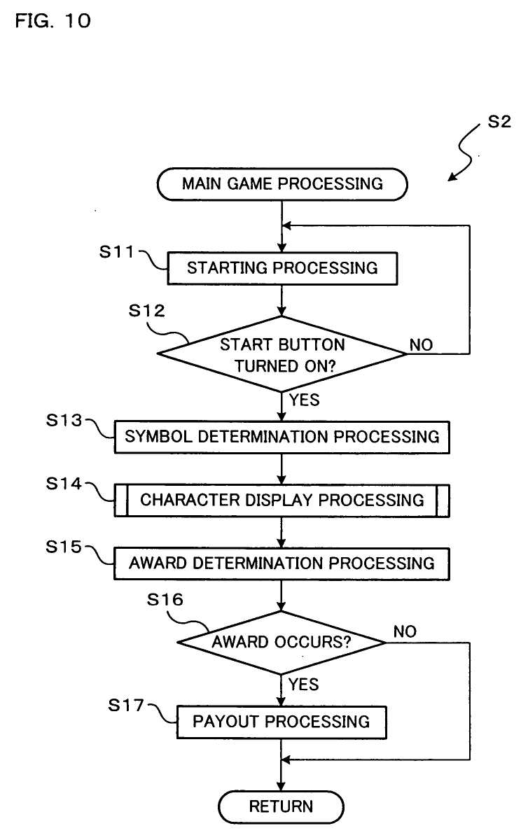

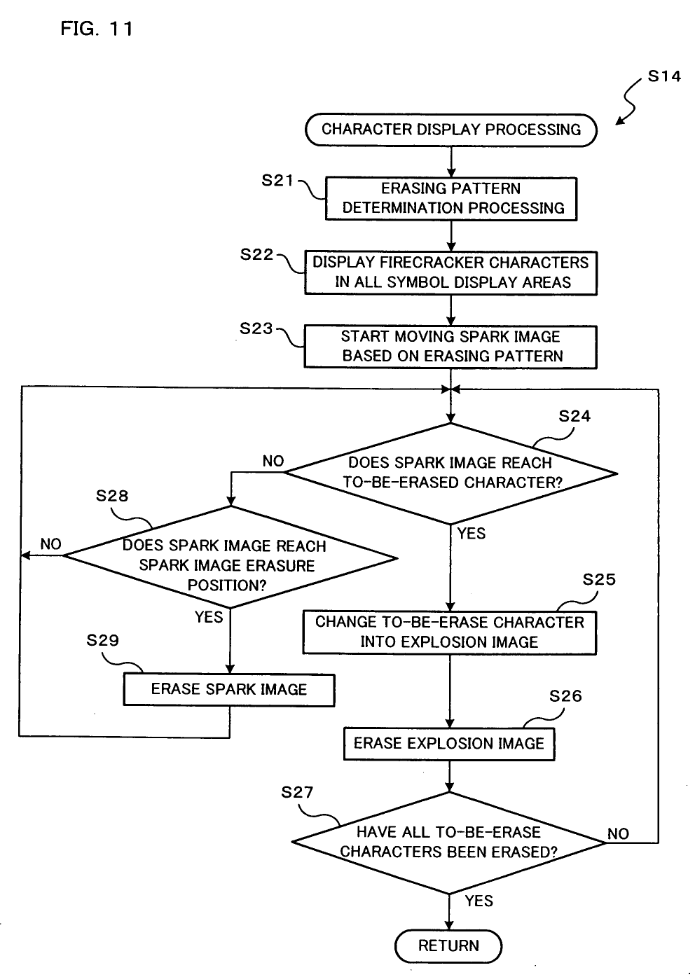

First, a gaming machine of the present invention will be generally described with reference to drawings. In a gaming machine of the present invention, fifteen symbol display areas 31 to 45, which constitute a symbol display section 7 shown in FIG. 4, are arranged in a matrix with five columns and three rows. When executing a game, before symbols 46 are displayed in the symbol display areas 31 to 45, firecracker characters 90 that conceal the symbols 46 associated with the respective symbol display areas 31 to 45 are displayed in the symbol display areas 31 to 45 (see FIG. 2). Here, the firecracker character 90 is a to-be-erased character. The firecracker characters 90 are erased one by one in an order from left to right of the lower display 6, based on an erasing pattern determined in a later-described character display processing S14 (see FIGS. 10 and 11). As a firecracker character 90 is erased, a symbol 46 that is associated with a corresponding symbol display area is displayed in this symbol display area (see FIG. 1). In the gaming machine according to the present invention, at a time when erasure of all firecracker characters 90 specified in the erasing pattern has been completed, whether there is an award or not is determined and the award is given based on symbol display areas corresponding to the firecracker characters 90 to be erased in the erasing pattern and symbols 46 displayed in those symbol display areas (see FIG. 3).

### First Embodiment

Next, a first embodiment of the present invention will be described in detail with reference to the accompanying drawings. In the first embodiment, the present invention is applied to a so-called video gaming machine. Here, a video gaming machine is a gaming machine that has an image display device such as a liquid crystal display and presents a game by displaying various symbol images on the image display device.

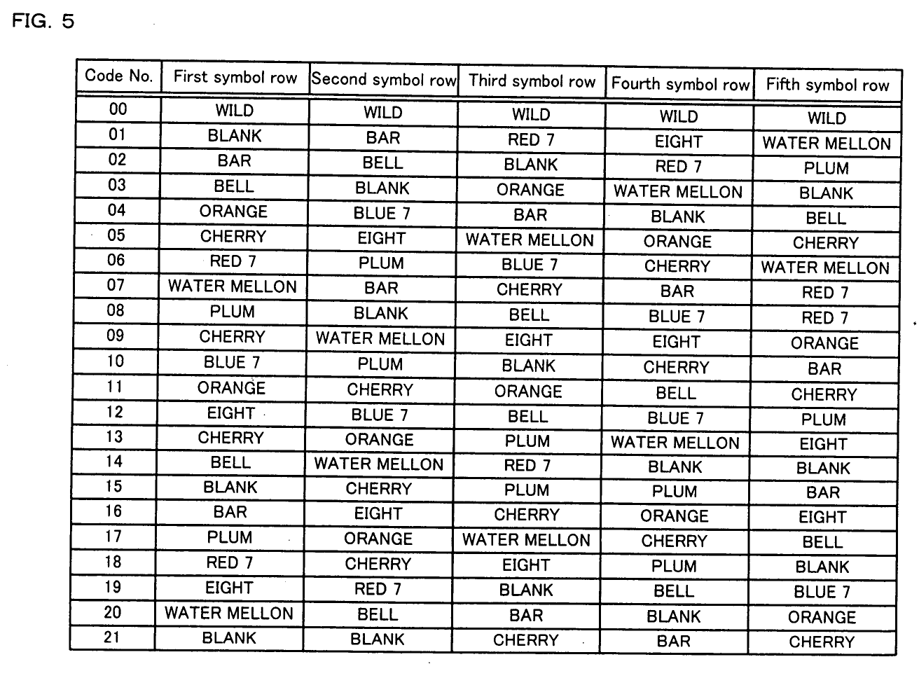

First, a game played in a gaming machine 1 according to the first embodiment will be generally described with reference to FIGS. 1 to 6. In the gaming machine 1 according to the first embodiment, a symbol display section 7 including five reel display areas 23 to 27 is displayed on a lower display 6 (see FIG. 4). Each of the reel display areas 23 to 27 shown in FIG. 4 has three symbol display areas. Thus, the symbol display section 7 is made up of fifteen symbol display areas 31 to 45 that are arrayed in three rows and five columns. Symbols 46 which will be displayed in the symbol display areas included in each of the reel display areas 23 to 27 are determined based on a column of symbols made up of eleven kinds of symbols WILD, RED 7, BLUE 7, BAR, EIGHT, BELL, WATER MELLON, PLUM, ORANGE, CHERRY, and BLANK (see FIG. 5). For example, for the symbol display areas 37 to 39 that are included in the reel display area 25, symbols 46 which will be displayed therein are determined based on a third column of symbols shown in FIG. 5.

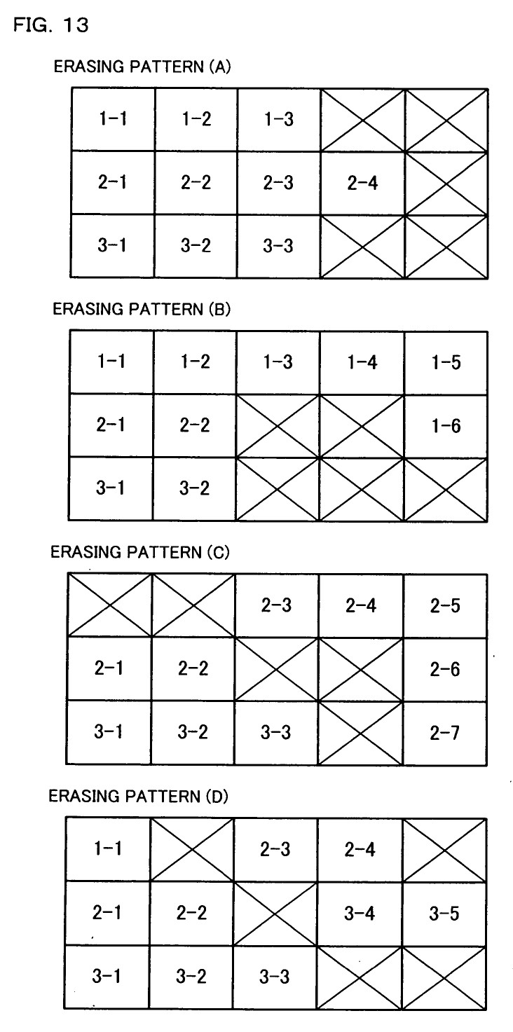

When symbols 46 which will be displayed in all of the symbol display areas 31 to 45 of the symbol display section 7 are determined, firecracker characters 90 are displayed in the symbol display areas 31 to 45 by a character display processing S14, before the determined symbols 46 are displayed therein (see FIG. 2). At this time, as shown in FIG. 2, several ignition cord images 95 that extend crisscross in the symbol display section 7 and a spark image 91 that moves on the ignition cord images 95 are displayed on the lower display 6. In the character display processing, in addition, an erasing pattern of the firecracker characters 90 is determined. An erasing pattern shown in FIGS. 1 to 3 is a data indicating an order of erasure on a symbol display area basis from a left end toward a right side of the symbol display section 7, that is an erasing pattern (C) which will be described later (see FIG. 13).

Then, on the lower display 6, the spark image 91 moves based on an erasing pattern determined, and to-be-erased characters specified in the erasing pattern are erased (see FIG. 1). In erasing a firecracker character 90 which is the to-be-erased character, this firecracker character 90 is firstly replaced with an explosion image 90A in the symbol display area. Then, when a predetermined period of time has elapsed since the explosion image 90A was displayed, the explosion image 90A is erased so that a symbol 46 concealed by the firecracker character 90 becomes visible to a player (see FIGS. 1 and 3).

Here, the symbol display area 39, which is located in a lower part of the reel display area 25 shown in FIGS. 1 to 3, is taken as an example. At a time when a game is started in the gaming machine 1, a firecracker character 90 is displayed in the symbol display area 39 as shown in FIG. 2. Then, when an erasing pattern is determined by the character display processing S14, firecracker characters 90 which are to-be-erased characters are erased one by one based on the erasing pattern (i.e., an erasing pattern (C)). When the spark image 91 moves along the ignition cord images 95 based on the erasing pattern (C) and reaches the symbol display area 39, the firecracker character 90 which is the to-be-erased character displayed in the symbol display area 39 is replaced with an explosion image 90A (see FIG. 2). When a predetermined period of time has elapsed since the explosion image 90A was displayed in the symbol display area 39, the explosion image 90A is erased. Since the explosion image 90A is erased from the symbol display area 39, a “PLUM” symbol 46 which is associated with the symbol display area 39 becomes visible (see FIG. 3).

In the above-described manner, the firecracker characters 90 displayed in the symbol display areas 31 to 45 are sequentially erased based on the determined erasing pattern, and finally there are a predetermined number of visible symbols 46 (e.g., ten symbols 46) (see FIG. 3). In the gaming machine 1, an award given to a player is determined based on a combination of visible symbols 46, that is symbols 46 displayed in the symbol display areas from which the firecracker characters 90 have been erased.

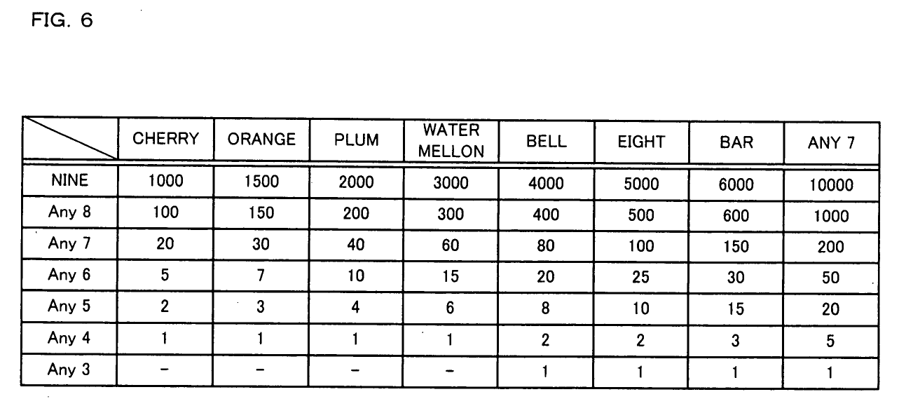

Here, in the gaming machine 1 of the first embodiment, an award differs depending on the number of the same symbols 46 among the ten symbols 46 displayed in the visible symbol display areas (see FIG. 6). That is, a win occurs when, irrespective of an arrangement of the ten symbols 46 displayed in the visible symbol display areas, the ten symbols 46 includes a combination of a predetermined number of the same symbols. An award corresponding to a kind of the same symbols and the number of the same symbols displayed is paid out. Among the eleven kinds of symbols mentioned above, the “WILD” symbol is a symbol counted as any of the other ten kinds of symbols 46. Moreover, in the first embodiment, the “RED 7” symbol and the “BLUE 7” symbol are treated as the same kind of symbols 46 as shown in FIG. 6. However, they may be individually counted as symbols of different kinds.

Here, taking a case shown in FIG. 3 as an example, a specific description will be given to determination of an award. As shown in FIG. 3, symbols 46 made visible by erasure of the firecracker character 90 are four “RED 7” symbols, two “PLUM” symbols, one “BLUE 7” symbol, one “BELL” symbol, one “WATER MELLON” symbol, and one “CHERRY” symbol. As described above, an award is determined based on a combination of symbols 46, which is defined by how many of the visible ten symbols 46 are the same kind of symbols 46 (see FIG. 6). That is, in the case shown in FIG. 3, a total number of “RED 7” and “BLUE 7” symbols is five, so that an “Any 5” combination of “ANY 7” is accomplished. Therefore, in the case shown in FIG. 3, a credit of “20” is awarded to a player. When, in the case shown in FIG. 3, any one of the “PLUM”, “BELL”, “WATER MELLON”, and “CHERRY” symbols is the “WILD” symbol, an “Any 6” combination of “ANY 7” is accomplished and therefore a credit of “50” is given.

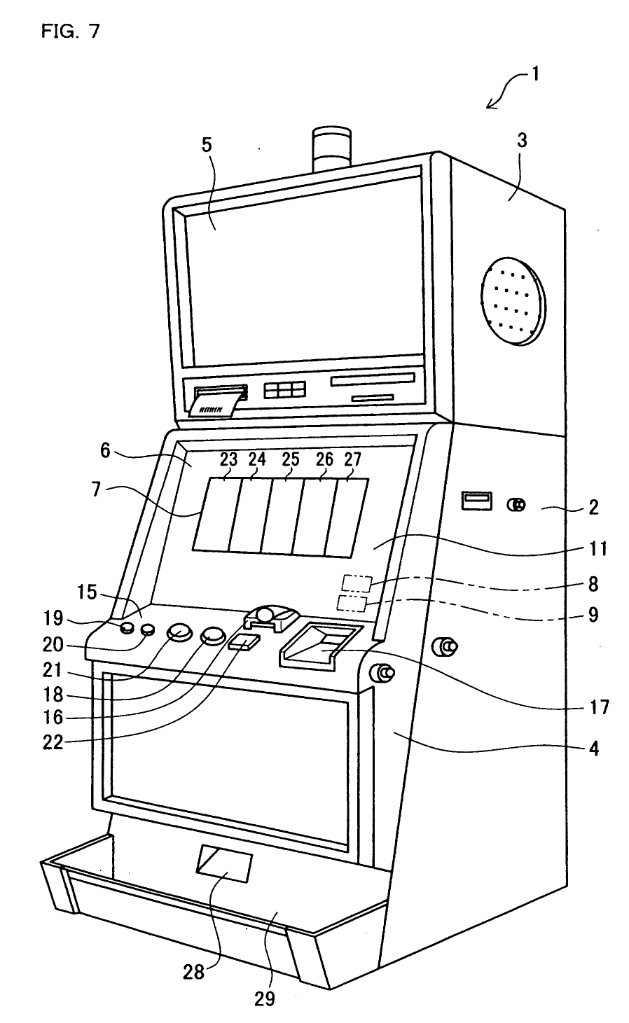

Next, a general construction of the gaming machine 1 according to the first embodiment will be described with reference to the accompanying drawings. FIG. 7 is a perspective view showing an appearance of the gaming machine 1 according to the first embodiment.

The gaming machine 1 according to the first embodiment includes a cabinet 2, a top box 3 placed on an upper side of the cabinet 2, and a main door 4 provided on a front face of the cabinet 2. An upper display 5 is provided on a front face of the top box 3. Here, the upper display 5 is made up of a known liquid crystal display. A playing manner, a payout table, and the like are displayed on the upper display 5.

On the other hand, a lower display 6 is provided on a front face of the main door 4. Here, the lower display 6 is made up of a known liquid crystal display. The lower display 6 has a symbol display section 7 including five reel display areas 23 to 27. Each of the reel display areas 23 to 27 is made up of three symbol display areas (see FIG. 4). That is, as shown in FIG. 4, the symbol display section 7 has fifteen symbol display areas, and one symbol 46 is associated with each of the fifteen symbol display areas. Symbols 46 displayed in three symbol display areas that constitute each of the reel display areas 23 to 27 are determined based on each of first to fifth columns of symbols (see FIG. 5). The first to fifth columns of symbols are associated with the reel display areas 23 to 27, respectively.

A touch panel 11 is provided on a front face of the lower display 6. A player is able to input various commands by operating the touch panel 11. In addition, the lower display 6 has a credit value indicator 8 and a payout number indicator 9. In the credit value indicator 8, a credit value currently held by a player is indicated. In the payout number indicator 9, an amount of an award which will be given on condition that a predetermined winning combination of symbols is stopped in the symbol display section 7 is indicated as a payout number.

A control panel 15, a coin reception slot 16, and a bill insertion slot 17 are provided below the lower display 6. The control panel 15 has buttons through which a player inputs command for making progress on a game. The coin reception slot 16 receives a coin, which is a game medium, into the cabinet 2. A start button 18, a change button 19, a CASHOUT button 20, a 1-BET button 21, and a MAX-BET button 22 are provided on the control panel 15. The start button 18 is an operation unit used for inputting a command to start a game in the gaming machine 1. The change button 19 is an operation unit used in asking a staff of a game arcade for an exchange. The CASHOUT button 20 is an operation unit used for inputting a command to pay out a number of coins, which is equivalent to a credit value held by a player, through a coin payout opening 28 into a coin tray 29, or a command to pay out a number of coins, which is equivalent to a credit value held by a player, in the form of a barcoded ticket. Here, in the first embodiment, one credit is equivalent to one coin. The 1-BET button 21 is an operation unit used for receiving a command to bet on a game one credit among all credits held by a player. The MAX-BET button 22 is an operation unit used for receiving a command to bet on a game a maximum credit value bettable on one game, among all credits held by a player. In the first embodiment, the maximum credit value bettable on one game is 50 credits. It may be possible to additionally provide various BET buttons such as a 3-BET button.

In the gaming machine 1 according to the first embodiment, a coin, a bill, or valuable electronic information (credit) equivalent to them are used as a game medium. However, a game medium applicable to the present invention is not limited thereto. For example, a medal, a token, electronic money, a ticket, and the like may be used as a game medium.

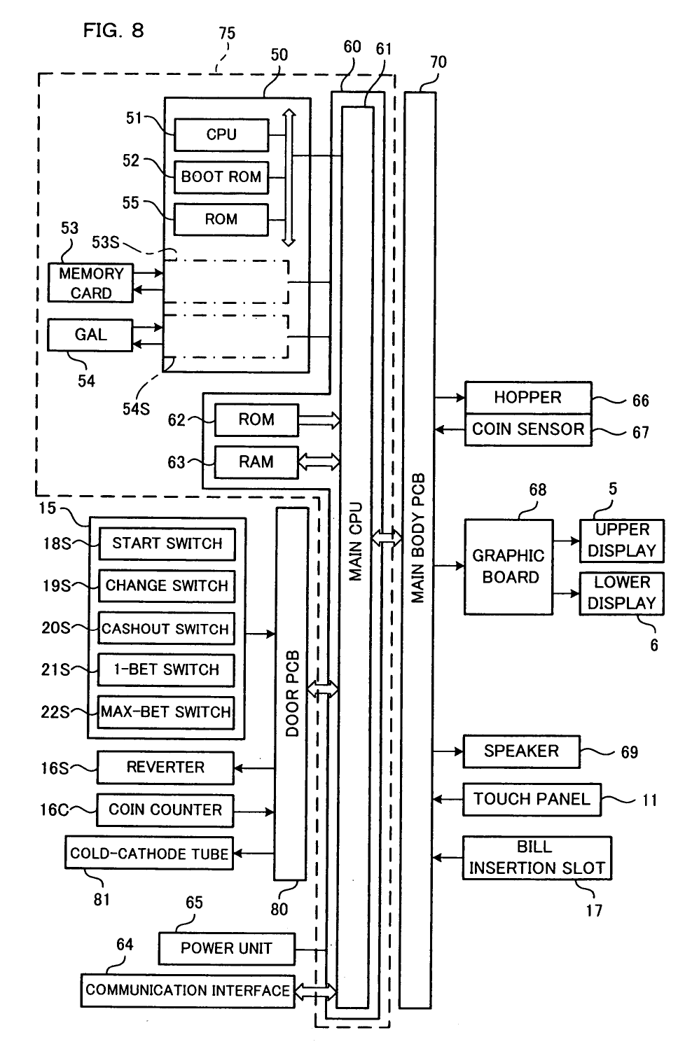

Next, a configuration of a control system of the gaming machine 1 according to the first embodiment will be described with reference to FIG. 8. FIG. 8 is a block diagram schematically showing a control system of the gaming machine 1 according to the first embodiment.

As shown in FIG. 8, a control system of the gaming machine 1 is basically made up of a mother board 60 and a gaming board 50. That is, the mother board 60 and the gaming board 50 constitute a game controller 75 that performs controllings for a game in the gaming machine 1.

The gaming board 50 will be described first. The gaming board 50 includes a CPU 51, a ROM 55, a boot ROM 52, a card slot 53S, and an IC socket 54S. The CPU 51, the ROM 55, and the boot ROM 52 are connected to each other via an internal bus. The card slot 53S is for a memory card 53. The IC socket 54S is for a GAL (General Array Logic) 54.

The memory card 53 is a memory medium formed of a non-volatile memory. A game program and a game system program (hereinafter referred to as a game program and the like) are stored in the memory card 53. The game program recorded on the memory card 53 includes a lottery program. The lottery program is a program for determining symbols 46 which will be displayed in the symbol display areas 31 to 45 shown in FIG. 4. The memory card 53 includes a symbol lottery table used for selecting symbols 46 which will be displayed in the symbol display areas 31 to 45. Here, the symbol lottery table is a table of correspondence between each kind of symbol 46 and a predetermined random number range. First, based on the symbol lottery table, symbols 46 for certain symbol display areas (e.g., symbol display areas 32, 35, 38, 41, and 44 located in middle parts of the respective reel display areas 23 to 27 shown in FIG. 4) are selected and associated respectively. Here, as shown in FIG. 5, code numbers are assigned to the symbols included in each of the first to fifth columns of symbols. Code numbers that correspond to symbols 46 associated with the symbol display areas located in the middle parts of the respective reel display areas are selected. As code numbers for the symbol display areas located in the middle parts of the respective reel display areas are determined, then code numbers for the symbol display areas located in upper and lower parts of the respective reel display areas are also determined. As a consequence, symbols 46 associated with the symbol display areas located in the upper and lower parts of the respective reel display areas are also determined based on the code numbers determined. The symbol lottery table is, for example, a table of correspondence between a predetermined random number range and a code number. In such a case, first, a main CPU 61 selects code numbers for symbol display areas 32, 35, 38, 41, and 44 located in middle parts of the respective reel display areas 23 to 27 based on the symbol lottery table, and then a main CPU 61 determines corresponded symbols 46 based on the code numbers which will be displayed in the symbol display areas 31 to 45.

Next, the mother board 60 will be described. The mother board 60 is formed using a general-purpose mother board on the market, that is, a printed wiring board mounted with basic components of a personal computer. The mother board 60 has a main CPU 61, a ROM 62, a RAM 63, and a communication interface 64.

The ROM 62 is a memory device such as a flash memory. Permanent data including for example a program such as a BIOS, which is executed by the main CPU 61, are stored in the ROM 62. When the main CPU 61 executes the BIOS, predetermined peripheral units are subjected to an initialization process, and the game program and the like stored in the memory card 53 start to be captured via the gaming board 50.

Data and programs that are used when the main CPU 61 operates are stored in the RAM 63. In addition, the RAM 63 can store therein various programs such as an authentication program, the game program and the like which are read out through the gaming board 50, and various information such as a credit value currently held by a player.

The communication interface 64 is a communication device that communicates through a communication line with a server and the like placed in a game arcade.

A main body PCB 70 and a door PCB 80 which will be described later are respectively connected to the mother board 60 via USBs. The power unit 65 is also connected to the mother board 60. When power is supplied from the power unit 65 to the mother board 60, the main CPU 61 of the mother board 60 is started, and further power is supplied through the PCI bus to the gaming board 50 so that the CPU 51 is started.

A hopper 66, a coin sensor 67, a graphic board 68, a speaker 69, a touch panel 11, a bill insertion slot 17, and the like are connected to the main body PCB 70.

The graphic board 68 controls image display on the upper display 5 and the lower display 6, based on a control signal from the main CPU 61. For example, during a game, the graphic board 68 displays firecracker characters 90, explosion images 90A, a spark image 91, and ignition cord images 95 in the symbol display section 7 of the lower display 6. Also, the graphic board 68 erases the firecracker characters 90 based on an erasing pattern, and displays the symbols 46 as a result of erasure of the firecracker characters 90. The graphic board 68 has a frame memory with two planes for displaying the symbol display section 7 on the lower display 6. Stored on one plane (hereinafter referred to as a first plane) of the frame memory are fifteen symbols 46 associated with the symbol display areas 31 to 45 which constitute the symbol display section 7. Stored on the other plane (hereinafter referred to as a second plane) of the frame memory are display modes of firecracker characters 90, explosion images 90A, a spark image 91, ignition cord images 95, and the like. In the graphic board 68, image data stored in the first and second planes of the frame memory are composed and written into a VRAM. In composing the image data stored in the first and second planes of the frame memory, the image data stored in the second plane take priority. Displaying on the lower display 6 during execution of a game is based on composition data thus written into the VRAM.

The control panel 15, a reverter 16S, a coin counter 16C, and a cold-cathode tube 81 are connected to the door PCB 80. The control panel 15 includes a start switch 18S corresponding to the start button 18, a change switch 19S corresponding to the change button 19, a CASHOUT switch 20S corresponding to the CASHOUT button 20, a 1-BET switch 21S corresponding to the 1-BET button 21, and a MAX-BET switch 22S corresponding to the MAX-BET button 22. When a button corresponding to each switch is operated by a player, the switch outputs an input signal to the main CPU 61.

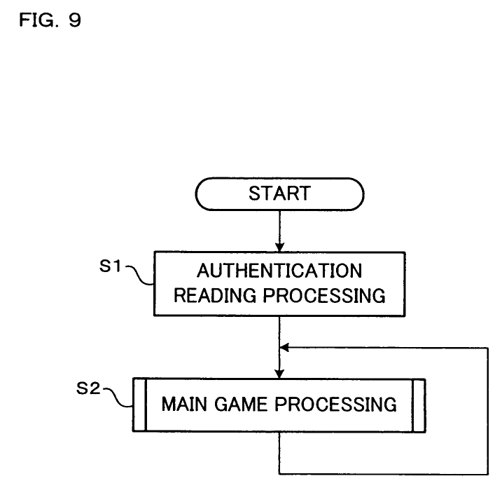

Next, a main control processing program executed in the gaming machine 1 according to the first embodiment will be described in detail with reference to the accompanying drawings. FIG. 9 is a flowchart showing a main control processing program. Here, it is presupposed that, in the gaming machine 1, the memory card 53 has already been inserted into the card slot 53S of the gaming board 50 and in addition the GAL 54 has already been mounted to the IC socket 54S of the gaming board 50.

First, when a power switch of the power unit 65 is turned on, the power unit 65 is powered up. The mother board 60 and the gaming board 50 are respectively booted up, and an authentication reading processing S1 is executed. In the authentication reading processing, the mother board 60 and the gaming board 50 execute different processings concurrently. To be more specific, in the gaming board 50, the CPU 51 reads out a preliminary authentication program that is stored in a boot ROM 52. In accordance with the preliminary authentication program thus read out, the CPU 51 performs a preliminary authentication for checking and proving that an authentication program is not falsified, before the mother board 60 downloads the authentication program. In the mother board 60, on the other hand, the main CPU 61 executes the BIOS that is stored in the ROM 62, and expands in the RAM 63 compressed data included in the BIOS. Then, the main CPU 61 executes the BIOS thus expanded in the RAM 63. The main CPU 61 also checks and initializes various peripheral units.

Then, the main CPU 61 reads out the authentication program stored in the ROM 55, and performs an authentication for checking and proving that a game program and the like stored in the memory card 53 that is inserted into the card slot 53S are not falsified. When this authentication processing is completed normally, the main CPU 61 writes the game program and the like thus authenticated, into the RAM 63. Subsequently, the main CPU 61 executes a download processing for reading payout rate setting data out of the GAL 54 through the gaming board 50, and the main CPU 61 writes the payout rate setting data thus read out into the RAM 63. After executing the above-described processing, the main CPU 61 completes the authentication reading processing.

Then, in S2, the main CPU 61 sequentially reads out of the RAM 63 the game program and the like that have been authenticated in the authentication reading processing S1, and executes them. Thus, the main CPU 61 executes a main game processing. By executing the main game processing, a game is played in the gaming machine 1 according to the first embodiment. The main game processing is executed repeatedly as long as the gaming machine 1 is supplied with power.

Next, the main game processing S2 will be described with reference to the drawings. FIG. 10 is a flowchart showing a main game processing program according to the first embodiment. Here, programs shown by the flowchart in FIG. 10 are stored in the memory card 53, expanded in the RAM 63 of the gaming machine 1, and executed by the main CPU 61.

As shown in FIG. 10, the main CPU 61 firstly executes a predetermined initialization processing. Then, the main CPU 61 executes a starting processing S11. In the initialization processing, data clearing about an item in a predetermined data field (e.g., a payout number counter) and the like are performed. In the starting processing S11, a player performs a bet operation by inserting a coin or using the 1-BET button 21 or the MAX-BET button 22, so that a coin insertion, a bet value, and the like are set.

Then, in S12, the main CPU 61 determines whether the start button 18 has been inputted or not. Here, whether the start button 18 has been inputted or not is determined based on whether an input signal has been received from the start switch 18S or not. When the start button 18 has not been inputted (S12: NO), the main CPU 61 returns the processing to the starting processing S11 again. At this time, operations such as changing a bet value are permitted. When the start button 18 has been inputted (S12: YES), the main CPU 61 subtracts from a currently-held credit value a bet value that has been set based on an operation of the 1-BET button 21 or the MAX-BET button 22. Then, the main CPU 61 stores the bet value into the RAM 63 as bet data.

Then, in S13, the main CPU 61 executes a symbol determination processing. In the symbol determination processing S13, one symbol 46 is determined by lottery for each of the symbol display areas 31 to 45 of the symbol display section 7, and associated with each of the symbol display areas 31 to 45. To be more specific, the main CPU 61 executes a random number generating program that is included in the lottery program stored in the RAM 63, to thereby sample a random number out of a predetermined random number range. Then, based on the random number thus sampled out and a symbol lottery table, the main CPU 61 determines, among several kinds of symbols, fifteen symbols 46 which will be displayed in the symbol display areas 31 to 45, respectively. The fifteen symbols 46 determined in the symbol determination processing S13 are associated with the respective symbol display areas 31 to 45, and stored as image data for the first plane of the frame memory of the graphic board 68. At a time of the symbol determination processing, the symbols 46 are not yet displayed in the symbol display areas 31 to 45.

Then, in S14, the main CPU 61 executes a character display processing. In the character display processing S14, firecracker characters 90 are displayed in the symbol display areas 31 to 45, and the firecracker characters 90 which are to-be-erased characters are sequentially erased based on an erasing pattern determined. The character display processing S14 is not described here because a detailed description thereof will be given later with reference to the drawings. In the character display processing, the main CPU 61 erases the firecracker characters 90 based on a predetermined erasing pattern, and displays ten of the symbols 46 concealed by the to-be-erased characters in the symbol display areas. Then, the main CPU 61 advances the processing to S15.

In S15, the main CPU 61 executes an award determination processing. In the award determination processing S15, whether a combination of the ten symbols 46 which have been concealed by the to-be-erased characters is a combination that causes any award or not is determined. More specifically, the main CPU 61 identifies a combination of symbols for the current game by referring to the erasing pattern that specifies to-be-erased characters and the symbols 46 associated with the respective symbol display areas 31 to 45. Then, the main CPU 61 determines whether a combination of the identified ten symbols 46 is a winning combination (see FIG. 6) or not, and determines an award (e.g., an amount of credits paid out) for the current game.

In S16, based on a result of the award determination processing S15, the main CPU 61 determines whether a winning combination is made or not. When it is determined that a winning combination is made (S16: YES), the main CPU 61 advances the processing to S17. When it is determined that a winning combination is not made (S16: NO), the main CPU 61 ends the main game processing S2. Here, in order to continuously start a next game, the processings subsequent to S1 are executed again.

Then, in S17, the main CPU 61 executes a payout processing in which the main CPU 61 gives a player an award based on a result of determination made in the award determination processing. At this time, by pressing the CASHOUT button 20, a payout may be made in the form of coins equivalent to a credit value (one credit is equivalent to one coin) or in the form of a barcoded ticket. As the payout processing S17 ends, the main game processing S2 ends. Here, in order to continuously start a next game, the processings subsequent to S1 are executed again.

Next, a character display processing S14 in the main game processing will be described in detail with reference to the drawings. FIG. 11 is a flowchart showing a character display processing program. In the above-described symbol determination processing S13, symbols 46 are associated with the respective symbol display areas 31 to 45, and image data of the symbols 46 being displayed in the respective symbol display areas 31 to 45 are stored in the first plane of the frame memory. Then, the main CPU 61 starts the character display processing S14.

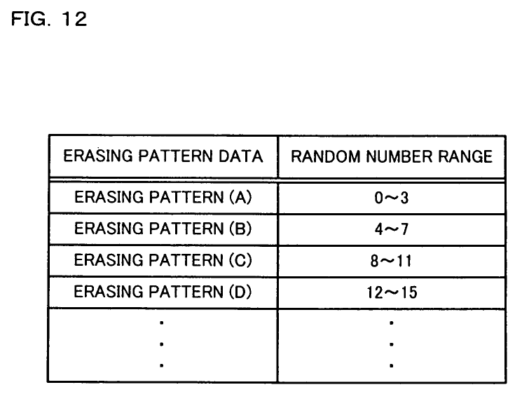

As shown in FIG. 11, as the character display processing S14 starts, the main CPU 61 firstly executes an erasing pattern determination processing S21. In the erasing pattern determination processing S21, among several erasing patterns provided, one erasing pattern is determined. More specifically, the main CPU 61 executes the random number generating program that is included in the lottery program, to thereby sample a random number out of a predetermined random number range. Then, based on a random number thus sampled out and an erasing pattern lottery table (see FIG. 12) in which a predetermined random number is assigned to each erasing pattern, the main CPU 61 determines one erasing pattern among the several erasing patterns provided. After determining an erasing pattern for the current game, the main CPU 61 stores the determined erasing pattern into the RAM 63 and advances the processing to S22.

An erasing pattern determined in the erasing pattern determination processing S21 will be described in detail with reference to the drawings. FIG. 13 is an explanatory view showing specific examples of the erasing pattern in the gaming machine according to the first embodiment. An erasing pattern determined in the erasing pattern determination processing S21 is data specifying a timing and a pattern of erasing firecracker characters 90 which are to-be-erased characters displayed in the symbol display areas 31 to 45. In this erasing pattern, basically, a specified order of erasing the firecracker characters 90 is from a left end toward a right side of the symbol display section 7. In addition, the firecracker characters 90 start to be erased basically from the ones displayed in the symbol display areas 31 to 33 which are located at the left end of the symbol display section 7. That is, the firecracker characters 90 start to be erased from the three upper, middle and lower symbol display areas included in the reel display area 23 which is located leftmost in the symbol display section 7. The firecracker characters 90 are then sequentially erased toward the right side on a symbol display area basis. The erasing pattern specifies the ten symbol display areas in which the to-be-erased characters should be displayed. Accordingly, after the firecracker characters 90 are erased based on the erasing pattern, symbols 46 are displayed in ten of the fifteen symbol display areas while firecracker characters 90 are displayed in remaining five of the fifteen symbol display areas.

Performed in the character display processing S14 are display and erasure of a spark image 91 and ignition cord images 95 as well as display and erasure of the firecracker characters 90. These display and erasure are performed based on the erasing pattern, too. To be more specific, first, simultaneously with when a game starts, a spark image 91 moves upward from a lower end of an ignition cord image 95 that is displayed leftmost on the lower display 6. When the spark image 91 reaches left ends of three ignition cord images 95 that extend across the upper, middle, and lower parts of the symbol display section 7, spark images 91 appear at the respective ends thereof and start moving rightward. That is, at this point of time, three spark images 91 are displayed in the symbol display section 7. The three spark images 91 are moved or erased in an order of symbol display areas specified by the erasing pattern. The ignition cord image 95 on which the spark image 91 moves has its portion erased after the spark image 91 passes the portion.

Here, a specific description will be given based on erasing patterns (A) to (D) shown in FIG. 13. The explanatory views of erasing patterns shown in FIG. 13 are schematic views of the fifteen symbol display areas included in the symbol display section 7 shown in FIG. 4. Numbers shown in one symbol display area, such as “2-3”, represents a correlation with another symbol display area and an order of erasure in terms of erasure of firecracker characters 90. As described above, an erasing pattern specifies that firecracker characters 90 are sequentially erased in an order from any of the three erasure starting point (which means the symbol display areas 31, 32, and 33) to the right side. Thus, a former number “2” of the numbers “2-3” indicates that an erasure starting point of a series of firecracker characters 90 is the symbol display area 32. On the other hand, in a case where a former number is “1”, it is indicated that an erasure starting point is the symbol display area 31. In a case where a former number is “3”, it is indicated that an erasure starting point is the symbol display area 33. A latter number “3” of the numbers “2-3” indicates an order of erasure within a series of firecracker characters 90. That is, referring to the explanatory view shown in FIG. 13, the symbol display area marked with “2-3” is a symbol display area in which displayed is a firecracker character 90 which should be erased thirdly during erasure of firecracker characters 90 starting from the symbol display area 32.

For example, according to an erasing pattern (A) shown in FIG. 13, firecracker characters 90 start to be erased from the one displayed in the symbol display area 31, and they are erased in an order of the one displayed in the symbol display area 34 and the one displayed in the symbol display area 37. In addition, firecracker characters 90 start to be erased from the one displayed in the symbol display area 32, and they are erased in an order of the one displayed in the symbol display area 35, the one displayed in the symbol display area 38, and the one displayed in the symbol display area 41. Further, firecracker characters 90 start to be erased from the one displayed in the symbol display area 33, and they are erased in an order of the one displayed in the symbol display area 36 and the one displayed in the symbol display area 39.

According to an erasing pattern (C), as shown in FIGS. 1 to 3, a firecracker character 90 is not erased from the symbol display area 31. In the erasing pattern (C), firecracker characters 90 start to be erased from the one displayed in the symbol display area 32, and they are erased in an order of the one displayed in the symbol display area 35, the one displayed in the symbol display area 37, the one displayed in the symbol display area 40, the one displayed in the symbol display area 43, the one displayed in the symbol display area 44, and the one displayed in the symbol display area 45. Like this, erasure of firecracker characters 90 may occur not only in an order simply going from left to right but also in an order going up and down on a symbol display area basis in the symbol display section 7. When a firecracker character 90 is erased from the symbol display area 33, then firecracker characters 90 are erased in an order of the one displayed in the symbol display area 36 and the one displayed in the symbol display area 39.

Thus, erasing patterns adopted in the gaming machine 1 specify that firecracker characters 90 are sequentially erased on a symbol display area basis from left to right in the symbol display section 7. Therefore, firecracker characters 90 are serially erased based on the erasing patterns. This provides a wider variety of displays in the symbol display section 7, to enhance pleasure of a player.

Here, referring to FIG. 11 again, the character display processing S14 will be described. After determining an erasing pattern in the erasing pattern determination processing S21, the main CPU 61 displays firecracker characters 90 in all of the symbol display areas 31 to 45 (S22). To be more specific, image data stored in the VRAM are displayed on the lower display 6 (see FIG. 2). The image data stored in the VRAM are, as described above, a composition of image data stored in the first plane of the frame memory of the graphic board 68 and image data stored in the second plane of the frame memory of the graphic board 68. In the image data stored in the first plane, symbols 46 are displayed in all the symbol display areas 31 to 45. In the image data stored in the second plane, firecracker characters 90 are displayed in all the symbol display areas 31 to 45 while spark images 91 and ignition cord images 95 are also displayed. Here, it should be noted that, in composing these two image data, the image data about firecracker characters 90 which are stored in the second plane take priority over the image data about symbols 46 which are stored in the first plane.

In a subsequent step S23, the main CPU 61 starts moving spark images 91 based on an erasing pattern. That is, the main CPU 61 displays spark images 91 at left ends of three ignition cords 95 extending in a lateral direction, and moves these spark images 91 rightward.

Then, in S24, the main CPU 61 determines whether the spark image 91 reaches a firecracker character 90 which is a to-be-erased character, or not. That is, based on an erasing pattern determined in the erasing pattern determination processing S21, the main CPU 61 determines whether it is a time for erasing a to-be-erased character displayed in a symbol display area or not.

When it is a time for erasing (S24: YES), the main CPU 61 firstly changes a firecracker character 90 which is the to-be-erased character, into an explosion image 90A (S25). When a predetermined period of time (for example 1 (s)) has elapsed since the explosion image 90A was displayed, the explosion image 90A is also erased from the symbol display area (S26). This means that the firecracker character 90 has been erased from the symbol display area, so that a player is allowed to see a symbol 46 determined in the symbol determination processing S13 with respect to this symbol display area. After erasing the explosion image 90A from the symbol display area, the main CPU 61 shifts the processing to S27.

When it is not a time for erasing (S24: NO), the main CPU 61 determines whether the spark image 91 reaches an erasure position or not (S28). Here, an erasure position of the spark image 91 means a position on an ignition cord image 95 near a symbol display area, at which erasure of the firecracker character 90 does not occur. Whether the spark image 91 reaches the erasure position or not is determined based on whether it is a time for erasing the spark image 91 or not. The time for erasing the spark image 91 is specified in the erasing pattern. When it is a time for erasing the spark image 91 (S28: YES), the main CPU 61 erases the spark image 91 (S29). After erasing the spark image 91, the main CPU 61 shifts the processing to S24. It may be possible to firstly change the spark image 91 into a smoke image as if a spark has been extinguished and then erase the spark image 91. When it is not a time for erasing the spark image 91 (S28: NO), the main CPU 61 returns the processing to S24.

In S27, based on the erasing pattern, the main CPU 61 determines whether all of the to-be-erased characters have been erased or not. When the firecracker characters 90 for the ten symbol display areas specified in the erasing pattern have been erased (S27: YES), the main CPU 61 ends the character display processing. When the firecracker characters 90 which are to-be-erased characters have not been fully erased (S27: NO), the main CPU 61 returns the processing to S24.

In the gaming machine 1, like this, the firecracker characters 90 are displayed in all the symbol display areas 31 to 45 included in the symbol display section 7. Therefore, it is difficult to know from which symbol display area 44 the firecracker character 90 will be erased. That is, it is difficult to know a combination of symbols 46. This can enhance player's expectation for an award.

### Second Embodiment

Next, a second embodiment of the present invention will be described in detail with reference to the accompanying drawings. In the second embodiment, the present invention is applied to a gaming machine 100 that adopts a mechanical reel. In the second embodiment, the same members and the same devices as those of the first embodiment will be denoted by the same reference numerals, and the same constructions as those of the first embodiment will not be described in detail.

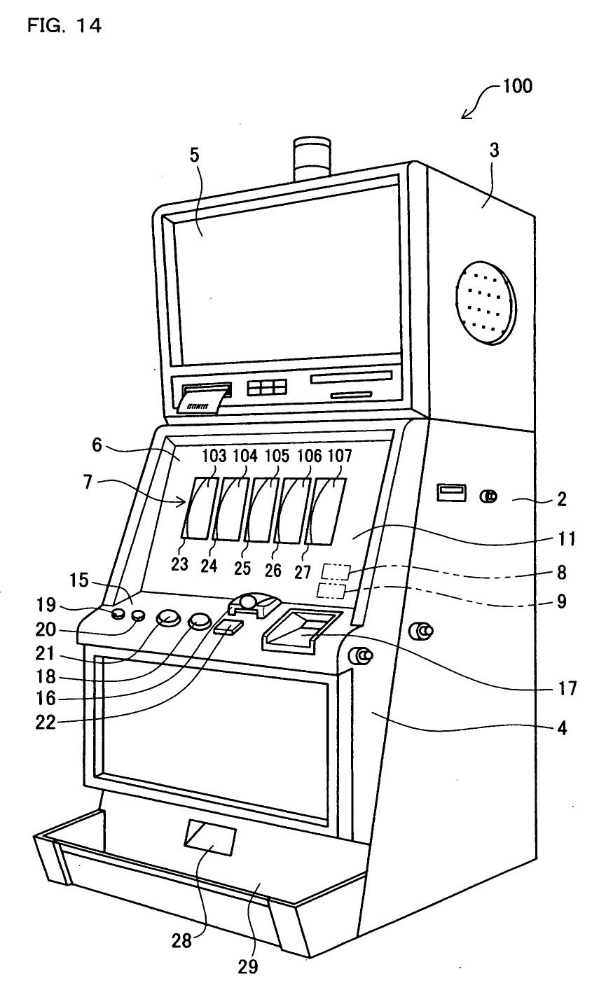

First, a general construction of the gaming machine 100 according to the second embodiment will be described with reference to the accompanying drawings. FIG. 14 is a perspective view showing an appearance of the gaming machine 100 according to the second embodiment. As shown in FIG. 14, a basic construction of the gaming machine 100 according to the second embodiment is the same as that of the gaming machine 1 according to the first embodiment. Here, unlike the so-called video gaming machine according to the first embodiment, the gaming machine 100 according to the second embodiment adopts a mechanical reel. Thus, the gaming machine 100 differs from the gaming machine 1 only in the mechanical reel. Accordingly, a detailed description will be given only to a construction of the mechanical reel.

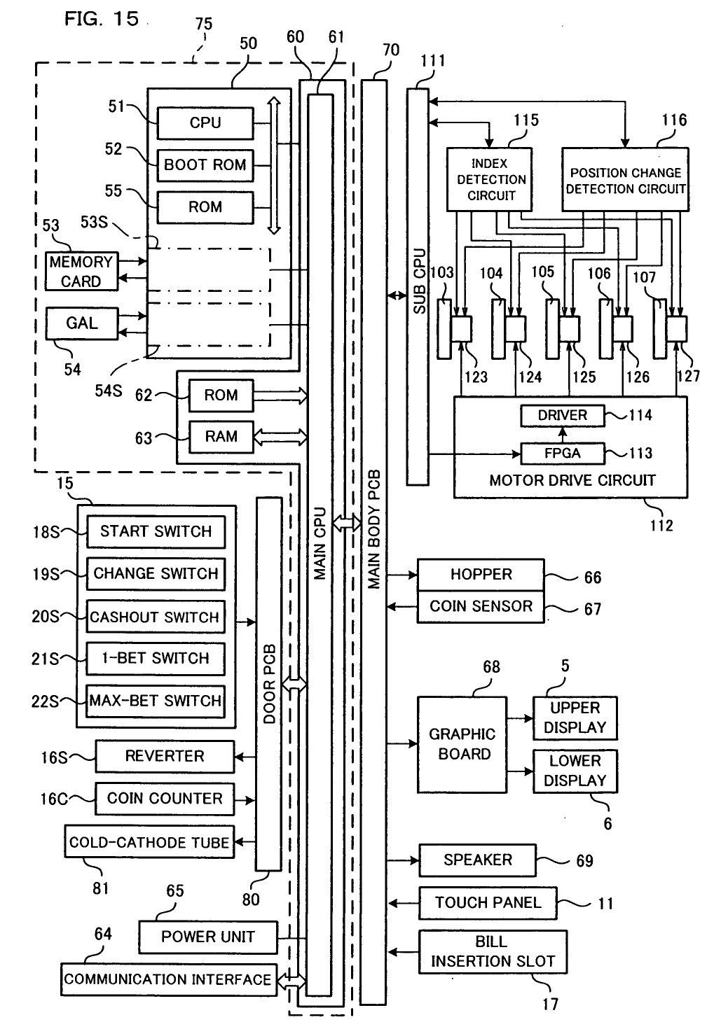

In the gaming machine 100, as shown in FIG. 14, a lower display 6 is provided on a front face of a main door 4. Here, the lower display 6 of the gaming machine 100 is formed of a transparent liquid crystal display. Reel display areas 23 to 27 are provided in a central portion of the lower display 6 so that an inside of a cabinet 2 of the gaming machine 100 can be seen. Inside the cabinet 2, mechanical reels 103 to 107 are rotatably disposed behind the reel display areas 23 to 27. Stepping motors 123 to 127 are provided for the mechanical reels 103 to 107, respectively. By controlling driving of the stepping motors 123 to 127, rotation of the mechanical reels 103 to 107 is controlled (see FIG. 15). First to fifth columns of symbols as in the first embodiment are shown on peripheral surfaces of the mechanical reels 103 to 107, respectively. Therefore, the columns of symbols shown on the peripheral surfaces of the mechanical reels 103 to 107 can be seen through the reel display areas 23 to 27.

In the gaming machine 100, like in the gaming machine 1, three symbols 46 are disposed in one reel display area. That is, each of the reel display areas 23 to 27 has three symbol display areas. As shown in FIG. 14, in the gaming machine 100 as well, a symbol display section 7 is made up of five reel display areas (reel display areas 23 to 27). Thus, the symbol display section 7 of the gaming machine 100 also includes symbol display areas 31 to 45. The symbol display areas 31 to 45 are arranged in the symbol display section 7, in a matrix with five columns and three rows.

Next, a control system of the gaming machine 100 according to the second embodiment will be described in detail with reference to the drawings. FIG. 15 is a block diagram showing a control system of the gaming machine 100 according to the second embodiment. As described above, the gaming machine 100 according to the second embodiment differs from the gaming machine 1 according to the first embodiment only in mechanical reels 103 to 107. Therefore, a construction regarding the mechanical reels 103 to 107 will be described in detail. The other constructions are the same as the above-described ones of the gaming machine 1 according to the first embodiment, and repeated description thereof will be omitted here.

As shown in FIG. 15, a sub CPU 111 as well as a hopper 66, a coin sensor 67, a graphic board 68, a speaker 69, a touch panel 11, and a bill insertion slot 17 is connected to a main body PCB 70. The sub CPU 111 controls rotation and stopping of the mechanical reels 103 to 107. A motor drive circuit 112 including an FPGA (Field Programmable Gate Array) 113 and a driver 114 is connected to the sub CPU 111. The FPGA 113 is an electronic circuit such as a programmable LSI, and functions as a control circuit for the stepping motors 123 to 127. The driver 114 functions as an amplifier circuit for a pulse which will be inputted to the stepping motors 123 to 127. The stepping motors 123 to 127, which are of 1-2 phase excitation type, are connected to the motor drive circuit 112. The stepping motors 123 to 127 rotate the respective mechanical reels 103 to 107.

In addition, an index detection circuit 115 and a position change detection circuit 116 are connected to the sub CPU 111. The index detection circuit 115 detects a position, e.g. a reference point, of the rotating mechanical reels 103 to 107. The index detection circuit 115 also detects out-of-step of the mechanical reels 103 to 107. The position change detection circuit 116 detects a change of a stopping position of the mechanical reels 103 to 107 after rotation of the mechanical reels 103 to 107 is stopped. For example, in a case where a winning combination of symbols is actually not made but nevertheless a player forcibly changes a stopping position so as to make a winning combination of symbols, the position change detection circuit 116 detects a change of a stopping position of the mechanical reels 103 to 107.

In the gaming machine 100 having a construction shown in FIGS. 14 and 15, like in the first embodiment, a main control processing program (FIG. 9), a main game processing program (FIG. 10), and a character display processing (FIG. 11) are executed. Basic contents of these programs are the same as in the first embodiment, and therefore detailed descriptions of these programs will be omitted. In the first embodiment, image data stored in the first and second planes of the frame memory are composed, and image data thus composed are displayed on the lower display 6. In the second embodiment, however, only image data concerning firecracker characters 90 and the like (which mean image data stored in the second plane) have to be displayed on the lower display 6. Therefore, composition of image data is not needed.

As thus far described above, in the gaming machine 1 of the present invention, upon start of a game, firecracker characters 90 are displayed in fifteen symbol display areas 31 to 45 arranged in a 3-times-5 matrix. When an erasing pattern is determined by the character display processing S14, the firecracker characters 90 which are to-be-erased characters are erased based on the erasing pattern in an order from left to right in the symbol display section 7. As a firecracker character 90 is erased, a symbol 46 concealed by this firecracker character 90 becomes visible in a corresponding symbol display area. After all of the to-be-erased characters specified in the erasing pattern are erased, ten symbols 46 are visible in the symbol display section 7. An award given to a player is determined based on a combination of these ten symbols 46.

In this construction, when a game starts, concealed symbols 46 which are decisive for an award are sequentially displayed. This makes a player feel an increased sense of tension for an award given in the gaming machine. In addition, firecracker characters 90 which conceal the symbols 46 are erased in an erasing pattern determined from several erasing patterns. The erasing pattern is not a simple one such as a conventional activated pay line. Therefore, it is difficult to guess in which symbol display areas symbols 46 decisive for an award will be displayed. This can enhance player's expectation. Further, in a state where all the firecracker characters 90 specified in the erasing pattern have been erased, a display mode of the symbol display section 7 is largely different from that of the conventional gaming machine because the firecracker characters 90 and also symbols 46 that have become visible as a result of erasure of the firecracker characters 90 are displayed. This provides a wider variety of display modes on the display. Thus, the gaming machine, which has a large visual appeal, can provide new pleasure.

The present invention is not limited to the above-described embodiments. It is evident that various improvements and modification can be made without departing from the spirit and scope of the present invention. For example, although in the above-described embodiment symbols placed in the respective symbol display areas are determined by the symbol determination processing S13, this is not limitative. It may be possible that, for example, symbols of the same kind are always fixedly placed in the respective symbol display areas. In addition, in the above-described embodiment, symbols placed in the respective symbol display areas are determined based on the column of symbols corresponding to the respective reel display areas 23 to 27, that is, they are determined on a reel display area basis. However, it may also be possible to determine symbols on a symbol display area basis by determining one symbol among several symbols for each of the symbol display areas 31 to 45.

In the above-described embodiment, the symbol display section 7 is made up of symbol display areas that are arranged in a 3-times-5 matrix. However, this is not limitative, and various modes are acceptable. For example, the symbol display section 7 may be made up of symbol display areas that are arranged in a honeycomb-like form or in a pyramid-like shape.

In addition, in the above-described embodiment, the firecracker characters 90 are displayed in all the symbol display areas. However, it may be possible that the firecracker characters 90 are displayed in a part of all the symbol display areas. Moreover, the number of firecracker characters 90 that are erased from the symbol display section 7 as to-be-erased characters may not be 10, and variously changed. Further, when changing the number of to-be-erased characters, the number may be increased and decreased based on various game conditions (such as a bet value, accomplishment of a predetermined combination of symbols, and the like).

While this invention has been described in conjunction with the specific embodiments outlined above, it is evident that many alternatives, modifications and variations will be apparent to those skilled in the art. Accordingly, the preferred embodiments of the invention as set forth above are intended to be illustrative, not limiting. Various changes may be made without departing from the spirit and scope of the invention as defined in the following claims.

1. A gaming machine comprising:
a display that displays thereon a symbol display area in which one of a plurality of symbols is arranged, and a symbol display frame made up of a plurality of symbol display areas; and
a game controller,
wherein, when executing a game, the game controller performs:
displaying, on the symbol display areas, characters for concealing symbols arranged in the symbol display areas;
sequentially erasing a part of the characters displayed on the symbol display areas, on a symbol display area basis; and
determining an award given to a player, based on a combination of symbols that become visible as a result of erasure of the characters.

2. The gaming machine according to claim 1, wherein, when executing a game, the game controller performs:
determining an erasing pattern that specifies an order of erasing the characters on a symbol display area basis in a predetermined direction from one end of the symbol display frame; and
based on the erasing pattern, sequentially erasing the characters on a symbol display area basis.

3. The gaming machine according to claim 1, wherein, when executing a game, the game controller performs displaying the characters on all the symbol display areas included in the symbol display frame, to thereby conceal symbols arranged in the symbol display areas.

4. The gaming machine according to claim 1, wherein, when executing a game, the game controller performs rearranging symbols in the symbol display frame.

5. The gaming machine according to claim 3, wherein, when executing a game, the game controller performs rearranging symbols in the symbol display frame.

6. The gaming machine according to claim 1, wherein the symbol display frame is made up of the plurality of symbol display areas that are arranged in a matrix.

7. The gaming machine according to claim 3, wherein the symbol display frame is made up of the plurality of symbol display areas that are arranged in a matrix.

8. A playing method for a gaming machine comprising a display that displays thereon a symbol display area in which one of a plurality of symbols is arranged, and a symbol display frame made up of a plurality of symbol display areas, wherein, when a game controller executes a game, the game controller performs:
displaying, on the symbol display areas, characters for concealing symbols arranged in the symbol display areas;
sequentially erasing a part of the characters displayed on the symbol display areas, on a symbol display area basis; and
determining an award given to a player, based on a combination of symbols that become visible as a result of erasure of the characters.

9. The playing method according to claim 8, wherein:
the game controller further performs determining an erasing pattern that specifies an order of erasing characters on a symbol display area basis in a predetermined direction from one end of the symbol display frame; and
when erasing the characters displayed on the symbol display areas, the game controller sequentially erases the characters based on the erasing pattern.

10. The playing method according to claim 8, wherein, when displaying characters on the symbol display areas, the game controller performs displaying the characters on all the symbol display areas included in the symbol display frame, to thereby conceal symbols arranged in the symbol display areas.

11. The playing method according to claim 8, wherein, when executing a game, the game controller performs rearranging symbols in the symbol display frame.

12. The playing method according to claim 10, wherein, when executing a game, the game controller performs rearranging symbols in the symbol display frame.

13. The playing method according to claim 8, wherein the symbol display frame is made up of the plurality of symbol display areas that are arranged in a matrix.

14. The playing method according to claim 10, wherein the symbol display frame is made up of the plurality of symbol display areas that are arranged in a matrix.

15. The gaming machine according to claim 2, wherein, when executing a game, the game controller performs displaying the characters on all the symbol display areas included in the symbol display frame, to thereby conceal symbols arranged in the symbol display areas.

16. The gaming machine according to claim 2, wherein, when executing a game, the game controller performs rearranging symbols in the symbol display frame.

17. The gaming machine according to claim 2, wherein the symbol display frame is made up of the plurality of symbol display areas that are arranged in a matrix.

18. The playing method according to claim 9, wherein, when displaying characters on the symbol display areas, the game controller performs displaying the characters on all the symbol display areas included in the symbol display frame, to thereby conceal symbols arranged in the symbol display areas.

19. The playing method according to claim 9, wherein, when executing a game, the game controller performs rearranging symbols in the symbol display frame.

20. The playing method according to claim 9, wherein the symbol display frame is made up of the plurality of symbol display areas that are arranged in a matrix.
